(19) United States
(12) Patent Application Publication
(10) Pub. No.: US 2008/0111781 A1
(43) Pub. Date: May 15, 2008

(54) GRAY-SCALE VOLTAGE PRODUCING MODULE FOR LIQUID CRYSTAL DISPLAY

(76) Inventor: Min Seok BAE, Yongin (KR)

Correspondence Address: MACPHERSON KWOK CHEN & HEID LLP, 2033 GATEWAY PLACE, SUITE 400, SAN JOSE, CA, 95110, US

(21) Appl. No.: 11/937,212

(22) Filed: Nov. 8, 2007

(30) Foreign Application Priority Data
Nov. 14, 2006 (KR) 10-2006-0112355

(51) Int. Cl. G09G 3/36

(52) U.S. Cl. 345/89

(57) ABSTRACT

A liquid crystal display providing a gray scale voltage at a range in which the transmittance of liquid crystals is non-linearly changed with respect to the applied gray-scale voltage. voltage distributor including an upper variable voltage distribution unit, a fixed voltage distribution unit and a lower variable voltage distribution unit, which are connected in series between high and low potential voltages; and a voltage output means for outputting a gray-scale voltage using the distribution voltages of the voltage distributor, wherein each of the upper and lower variable voltage distribution units comprises a plurality of variable resistor sections connected in series, and the fixed voltage distribution unit comprises a plurality of variable resistor sections connected in series; a liquid crystal display having the same; and a driving method thereof.

### CROSS-REFERNCE TO RELATED PATENT APPLICATION

This application claims priority to Korean Patent Application No. 2006-0112355, filed on Nov. 14, 2006, in the Korean Intellectual Property Office, the disclosure of which is incorporated by reference herein.

### BACKGROUND OF THE INVENTION

1. Field of Invention

The present invention relates to a liquid crystal display having enhanced image quality and, more particularly, to a liquid crystal display that adjusts the amplitude of the gray-scale voltage accordance with a property of the liquid crystal.

2. Discussion of the Background

A liquid crystal display (LCD) comprises an LCD panel having thin film transistor (TFTs) and pixel capacitors having liquid crystals provided between common and pixel electrodes, and a controller for controlling the operation of the LCD panel.

According to the operation of such an LCD, the arrangement of liquid crystal molecules is changed by changing the electric field between the common and pixel electrodes through a TFT. The light transmittance of liquid crystals is varieded through such a change in the arrangement of liquid crystal molecules so that desired images can be displayed.

A gray-scale voltage is applied to the pixel electrode so as to change the electric field between the common and pixel electrodes. The liquid crystals change their transmittance depending on the applied gray-scale voltage. That is, the arrangement of the liquid crystals is changed within the voltage range of the applied gray-scale voltage. However, the light transmittance of the liquid crystals is linearly or non-linearly changed, depending on the gray-scale voltage applied within the voltage range. There is a problem in that the gray-scale representation is not exactly performed at the range in which the light transmittance of the liquid crystals is non-linearly changed.

### SUMMARY OF THE INVENTION

The present invention provides a gray-scale voltage which accurately controls the light transmittance of the liquid crystals.

An exemplary embodiment of the present invention provides a gray-scale voltage producing module comprising a voltage distributor that includes an upper variable voltage distribution unit for outputting a plurality of distribution voltages, a fixed voltage distribution unit, and a lower variable voltage distribution unit which are connected in series between high and low potential voltages. A voltage output means outputs the gray-scale voltage using the distribution voltages of the voltage distributor, wherein each of the upper and lower variable voltage distribution units comprises a plurality of variable resistor sections connected in series, and the fixed voltage distribution unit comprises a plurality of resistor sections connected in series.

Each of the variable resistor sections may comprise a switch and a first resistor connected in series with each other, and a second resistor connected in parallel with the serially connected switch and first resistor. The module may further comprise a controller for controlling the operation of the switch in the variable resistor section. The controller comprises two output terminals. The switches of the plurality of variable resistor sections in the upper variable voltage distribution unit are connected to one of the output terminals of the controller The switches of the plurality of variable resistor sections in the lower variable voltage distribution unit are connected to the other of the output terminals of the controller.

The voltage levels of the distribution voltages output by the upper variable voltage distribution unit may be higher than the distribution voltages output by the fixed voltage distribution unit and the lower variable voltage distribution unit, and the voltage levels of the distribution voltages output by the lower variable voltage distribution unit may be lower than those of the distribution voltages output by the fixed voltage distribution unit.

The voltage output means may comprise a multiplexer unit for outputting some of the distribution voltages of the voltage distributor as gray-scale selection voltages; and a gray-scale voltage output unit for generating the gray-scale voltage using the gray-scale selection voltages.

An exemplary embodiment of the present invention, there is provided a liquid crystal display (LCD), comprising an LCD panel for displaying an image using liquid crystals; and a gray-scale voltage producing module for applying a gray-scale voltage to the liquid crystals, wherein the light transmittance of the liquid crystals is non-linearly or linearly changed depending on the applied gray-scale voltage, and the gray-scale voltage producing module comprises a variable voltage distribution unit for generating the gray-scale voltage at a range in which the transmittance of the liquid crystals is non-linearly changed.

The gray-scale voltage producing module may comprise a voltage distributor for outputting a plurality of distribution voltages through the variable voltage distribution unit and the fixed voltage distribution unit, which are connected in series; and a voltage output means for outputting the gray-scale voltage using the distribution voltages of the voltage distributor, wherein the variable voltage distribution unit includes a plurality of variable resistor sections connected in series.

The variable voltage distribution unit includes upper and lower variable voltage distribution units; the voltage levels of the distribution voltages output by the upper variable voltage distribution unit are higher than those of the distribution voltages output by the fixed voltage distribution unit and the lower variable voltage distribution unit; and the voltage levels of the distribution voltages output by the lower variable voltage distribution unit are lower than those of the distribution voltages output by the fixed voltage distribution unit.

Each of the variable resistor sections may comprise a switch and a first resistor connected in series to each other, and a second resistor connected in parallel to the serially connected switch and first resistor.

The LCD may further comprise a controller for controlling the operation of the switch in the variable resistor section. The controller comprises two output terminals; the switches of the plurality of variable resistor sections in the upper variable voltage distribution unit are connected to one of the output terminals of the controller; and the switches of the plurality of variable resistor sections in the lower variable voltage distribution unit are connected to the other of the output terminals of the controller.

An exemplary embodiment of the present invention, there is provided a driving method for an LCD, comprising the steps of generating a plurality of distribution voltages by respectively applying high and low potential voltages to both terminals of a voltage distributor, the voltage distributor including an upper variable voltage distribution unit, a fixed voltage distribution unit and a lower variable voltage distribution unit, which are connected in series. Each of the upper variable voltage distribution unit, the fixed voltage distribution unit and the lower variable voltage distribution unit have a plurality of resistor sections. A plurality of gray-scale voltages are generated using the plurality of distribution voltages and the plurality of gray-scale voltages are applied to the liquid crystals in an LCD panel, wherein the light transmittance of the liquid crystals is non-linearly or linearly changed depending on the applied gray-scale voltages. The range of the gray-scale voltages in which the transmittance of the liquid crystals is non-linearly changed is generated using the distribution voltages generated by the upper and lower variable voltage distribution units.

The resistance of the resistor sections in at least one of the upper and lower variable voltage distribution units may be variably changed.

### BRIEF DESCRIPTION OF THE DRAWINGS

The above and other objects, features and advantages of the present invention will become apparent from the following description of preferred exemplary embodiments given in conjunction with the accompanying drawings, in which:

FIG. 1 is a block diagram of a liquid crystal display according to an exemplary embodiment of the present invention;

FIG. 2 is a block diagram of a data driver according to the exemplary embodiment of the present invention;

FIG. 3 is a view conceptually showing a gray-scale voltage generator according to the exemplary embodiment of the present invention;

FIG. 4 is a graph illustrating an operational property of liquid crystals according to the exemplary embodiment of the present invention;

FIG. 5 is a detailed circuit diagram of a voltage distributor according to the exemplary embodiment of the present invention; and

FIG. 6 is a detailed circuit diagram of a voltage distributor according to a modification of the exemplary embodiment of the present invention.

### DETAILED DESCRIPTION OF THE EXEMPLARY EMBODIMENT

Hereinafter, preferred exemplary embodiments of the present invention will be described in detail with reference to the accompanying drawings.

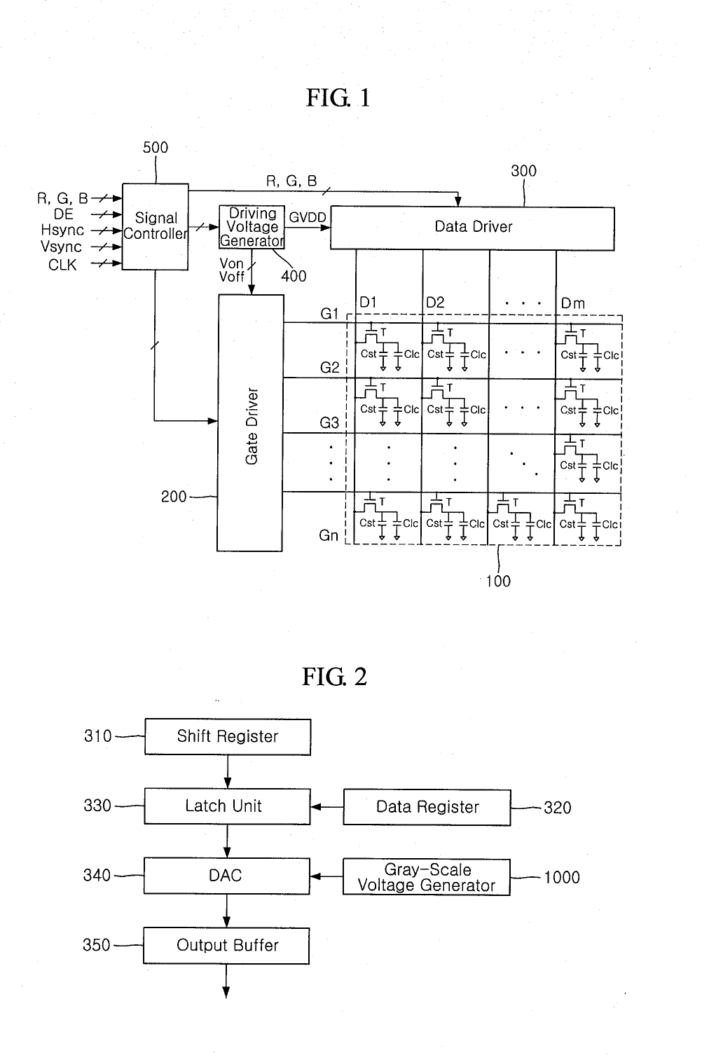

FIG. 1 is a block diagram of a liquid crystal display (LCD) according to an exemplary embodiment of the present invention, and FIG. 2 is a block diagram of a data driver according to the exemplary embodiment of the present invention.

Referring to FIGS. 1 and 2, the display device according to this exemplary embodiment comprises an LCD panel 100, a gate driver 200, a data driver 300, a driving voltage generator 400, and a signal controller 500.

The LCD panel 100 comprises a plurality of gate lines G1 to Gn extending approximately in an abscissa direction; a plurality of data lines D1 to Dm extending in an ordinate direction to intersect the gate lines G1 to Gn; and pixels provided at intersection regions of the gate and data lines G1 to Gn and D1 to Dm. The pixel comprises a thin film transistor (TFT) T, a storage capacitor Cst and a liquid crystal capacitor Clc. Each pixel includes red R, green G and blue B pixels, thus displaying full colors through combinations of the red, green and blue pixels. The LCD panel 100 comprises a TFT substrate (not shown) having TFTs T, the gate and data lines G1 to Gn and D1 to Dm, pixel electrodes for the liquid crystal capacitors provided thereon; a common electrode substrate (not shown) having black matrixes, color filters and a common electrode for the liquid crystal capacitors Clc provided thereon; and liquid crystals (not shown) interposed between the TFT substrate and the common electrode substrate.

Gate terminals of the TFTs T are connected to the gate lines G1 to Gn; source terminals thereof are connected to the data lines D1 to Dm; and drain terminals thereof are connected to the pixel electrodes of the liquid crystal capacitors Clc, respectively. Thus, the TFT T is operated in accordance with a gate turn-on voltage applied to the gate line and supplies a data signal (i.e., a gray-scale voltage) from the data line to the pixel electrode of the pixel capacitor such that an electric field between both ends of the liquid crystal capacitor is changed. Accordingly, the arrangement of the liquid crystals in the LCD panel 100 is changed so that the transmittance of light supplied from a backlight can be varied.

The pixel electrodes of the liquid crystal capacitors Clc may have a pattern with a plurality of cut-away portions and/or protrusions as a domain regulating means for controlling the orientation of liquid crystals, and the common electrode may have a protrusion and/or cut-away pattern. Preferably, the liquid crystals of this exemplary embodiment are oriented in a vertical orientation type.

A controller for supplying signals for driving the LCD panel 100 is provided at the outside of the LCD panel 100 so configured. The controller comprises a gate driver 200, a data driver 300, a driving voltage generator 400 and the signal controller 500.

The gate driver 200 and/or data driver 300 may be mounted on a lower display plate of the LCD panel 100. Alternatively, the gate driver 200 and/or data driver 300 may be mounted on an additional printed circuit board (PCB) and electrically connected through a flexible printed circuit board (FPC). Preferably, the gate and data drivers 200 and 300 of this exemplary embodiment are manufactured in the form of at least one driving chip to be mounted. In addition, the voltage generator 400 and the signal controller 500 are preferably mounted on a PCB to be electrically connected to the LCD panel 100 through a FPC.

The signal controller 500 receives input image signals, i.e., pixel data (R, G and B) and input control signals for controlling the display thereof, e.g., a vertical synchronization signal (Vsync), a horizontal synchronization signal (Hsync), a main clock (CLK), a data enable signal (DE) and the like, all of which are supplied from an external graphic controller (not shown). The signal controller 500 processes such pixel data to be suitable for operational conditions of the LCD panel 100, generates gate and data control signals, and transmits the gate control signal to the gate driver 200. The pixel data are rearranged in accordance with the arrangement of the pixels of the LCD panel 100. Further, the gate control signal includes a vertical synchronization start signal for instructing the output start of a gate turn-on voltage Von, a gate clock signal, an output enable signal and the like. The data control signal includes a synchronization start signal for communicating the transmission start of the pixel data, a load signal for applying a data voltage to a corresponding data line, a polarity signal for reversing the polarity of the gray-scale voltage with respect to a common voltage, a data clock signal, and the like.

The driving voltage generator 400 generates a variety of driving voltages required in driving an LCD using external power input from an external power supply. The driving voltage generator 400 generates a reference voltage GVDD, a gate turn-on voltage Von, a gate turn-off voltage Voff and a common voltage. Further, the driving voltage generator 400 applies the gate turn-on voltage Von and the gate turn-off voltage Voff to the gate driver 200 according to a control signal from the signal controller 500, and applies the reference voltage GVDD to the data driver 300. The reference voltage GVDD is used as a reference voltage for generating the gray-scale voltage which drives the liquid crystals.

The gate driver 200 applies the gate turn-on/turn-off voltage Von/Voff of the driving voltage generator 400 to the gate lines G1 to Gn in accordance with the external control signals. Accordingly, the corresponding TFT T can be controlled such that the gray-scale voltage to be applied to each pixel is applied to the corresponding pixel.

The data driver 300 generates the gray-scale voltage using the control signal of the signal controller 500 and the reference signal GVDD of the driving voltage generator 400 and applies the gray-scale voltage to each of the data lines D1 to Dm. That is, the data driver 300 converts the input pixel data in digital form into the data signal (i.e., the gray-scale voltage) in analog form based on the reference voltage GVDD.

As show in FIG. 2, the data driver 300 of this exemplary embodiment comprises a shift register 310 for sequentially transmitting sampling signals; a data register 320 for temporarily storing the pixel data; a latch unit 330 for sampling and latching the pixel data through the sampling signals; a gray-scale voltage generator 1000 for generating a plurality of the gray-scale voltages, a digital-to-analog converter (DAC) 340 for converting the latched pixel data into the gray-scale voltage; and an output buffer 350 for supplying the converted pixel data to the data lines D1 to Dm.

The shift register 310 generates the sampling signal and supplies it to the latch unit 330 based on the control signal supplied from the signal controller 500. The data register 320 temporarily stores the pixel data (R, G and B) sequentially input from the signal controller 500. The latch unit 330 samples and latches the pixel data (R, G and B) temporarily stored in the data register 320 corresponding to the sampling signals. At this time, the latch unit 330 simultaneously latches and outputs the pixel data corresponding to the respective data lines D1 to Dm. The gray-scale voltage generator 1000 has a voltage distributor, and outputs the plurality of gray-scale voltages after distributing the reference voltage GVDD using the voltage distributor. The DAC 340 converts the pixel data output from the latch unit 330 into the data signal in analog form, i.e., the gray-scale voltage, to output it to the output buffer 360. The output buffer 350 receives the gray-scale voltage output from the DAC 340, and outputs the gray-scale voltage after sampling and holding them.

Although it has been described in the aforementioned description that the gray-scale voltage generator 1000 is provided in the data driver 300, the present invention is not limited thereto. That is, the gray-scale voltage generator 1000, as an additional module, may be provided in the outside of the data driver 300.

In this exemplary embodiment, the reference voltage GVDD is distributed through the voltage distributor of the gray-scale generator 1000 to be output as the plurality of gray-scale voltages, and the light transmittance of liquid crystals is changed through such gray-scale voltages.

Hereinafter, the gray-scale voltage generator will be described with reference to the following drawings.

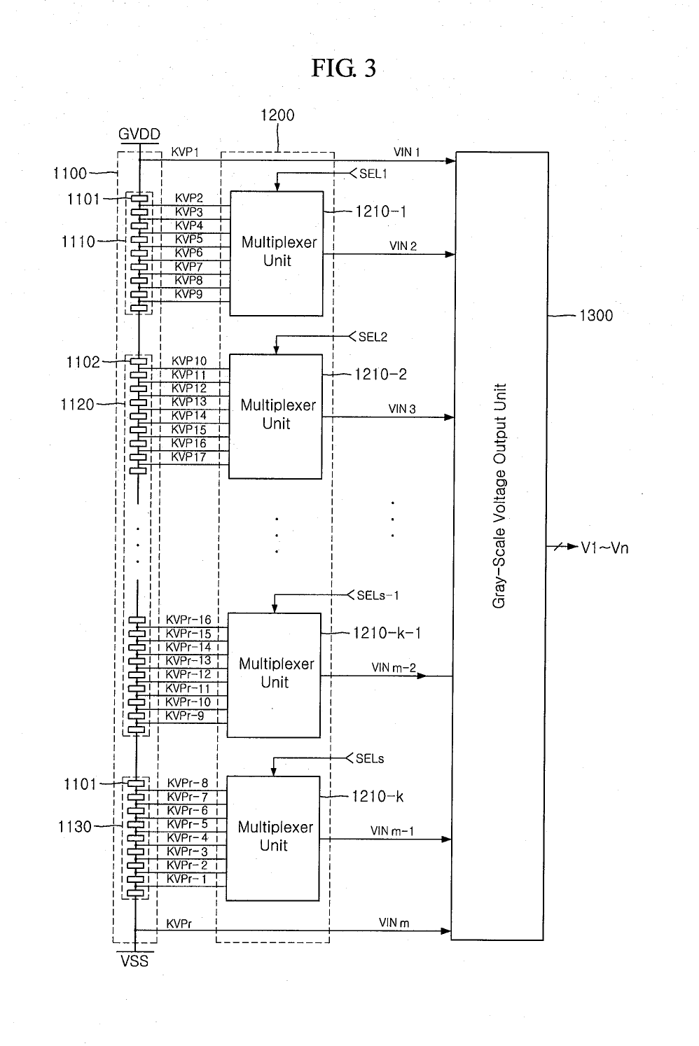

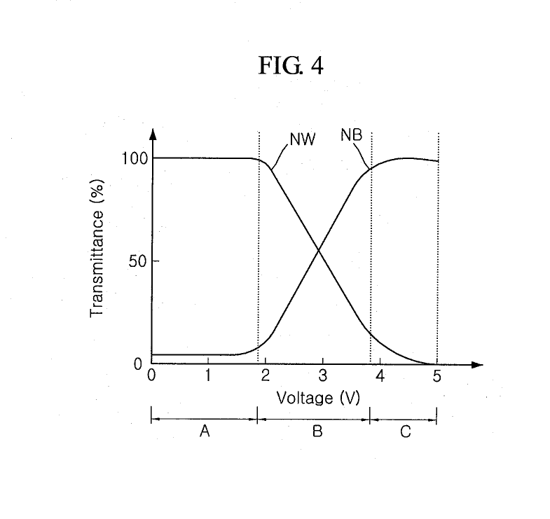

FIG. 3 is a view schematically showing the gray-scale voltage generator according to the exemplary embodiment of the present invention. FIG. 4 is a graph illustrating an operational property of liquid crystals according to the exemplary embodiment of the present invention.

Referring to FIG. 3, the gray-scale voltage generator according to the present exemplary embodiment comprises a voltage distributor 1100, a multiplexer unit 1200 and a gray-scale voltage output unit 1300.

The voltage distributor 1100 generates a plurality of distribution voltages KVP1 to KVPr using the reference voltage GVDD. The multiplexer unit 1200 selects some of the plurality of distribution voltages KVP1 to KVPr and outputs them as gray-scale voltages VIN1 to VINm. The gray-scale voltage output unit 1300 generates gray-scale voltages V1 to Vn using the gray-scale voltages VIN1 to VINm and then outputs the gray-scale voltages V1 to Vn.

The voltage distributor 1100 comprises an upper variable voltage distribution unit 1110, a fixed voltage distribution unit 1120 and a lower variable voltage distribution unit 1130, which are connected in series between first and second input terminals to which the reference voltage GVDD and ground voltage VSS are respectively applied. Each of the upper and lower variable voltage distribution units 1110 and 1130 comprises a plurality of variable resistor sections 1101 connected in series. The resistance of the variable resistor section 1101 is changed in accordance with the external control signals. Further, the fixed voltage distribution unit 1120 comprises a plurality of resistor sections 1102 connected in series. The reference voltage GVDD applied to the first input terminal is distributed by the aforementioned upper variable voltage distribution unit 1110, fixed voltage distribution unit 1120 and lower variable voltage distribution unit 1130 to be divided into the plurality of distribution voltages KVP1 to KVPr.

The distribution voltages KVP1 to KVP9 and KVPr-8 to KVPr generated from the upper and lower variable voltage distribution units 1110 and 1130 are used to generate the gray-scale voltage at a range in which the transmittance of liquid crystals is non-linearly changed with respect to the applied gray-scale voltage. That is, the variable resistor sections 1101 are provided in the upper and lower variable voltage distribution units 1110 and 1130, so that the voltage levels of the distribution voltages KVP1 to KVP9 and KVPr-8 to KVPr generated through the variable resistor sections 1110 can be varied as necessary. Accordingly, the value of the gray-scale voltage at the range in which the transmittance of liquid crystals is non-linearly changed with respect to the applied gray-scale voltage can be more finely selected.

Preferably, the voltage level of the distribution voltages KVP1 to KVP8 generated by the upper variable voltage distribution unit 1110 is highest, and the voltage level of the distribution voltages KVPr-8 to KVPr generated by the lower variable voltage distribution unit 1130 is lowest.

As described above, in this exemplary embodiment, the gray-scale voltage generator 1000 distributes the reference voltage GVDD through the voltage distribution unit 1100 to generate the plurality of distribution voltages KVP1 to KVPr, and generates the gray-scale voltages V1 to Vn using some of the plurality of distribution voltages KVP1 to KVPr. The LCD having the aforementioned gray-scale voltage generator 1100 displays images by changing the light transmittance of liquid crystals using the gray-scale voltages V1 to Vn.

Here, the liquid crystals have a range in which the transmittance thereof is linearly changed (i.e., a linear range B) and ranges in which the transmittance thereof is non-linearly changed (i.e., non-linear ranges A and C), depending on an applied voltage (i.e., the gray-scale voltage) as shown in FIG. 4. FIG. 4 illustrates the light transmittances of the liquid crystals depending on an applied voltage in NW (Normally-White) and NB (Normally-Black) modes. Here, there is a problem in that it is difficult to represent a fine gray-scale in the non-linear regions A and C. To solve such a problem, the gray-scale voltage in the non-linear regions A or C should be more finely controlled.

Preferably, the amplitude of the gray-scale voltage is changed by adjusting a voltage distribution rate at the range in which the gray-scale voltage in the non-linear regions A or C is generated in this exemplary embodiment. At this time, the voltage distribution rate can be adjusted by changing resistance in the voltage distributor 1100. That is, the non-linear regions A and C are divided into a region to which a gray-scale voltage with a high-voltage level is applied and a region to which a gray-scale voltage with a low-voltage level is applied. The gray-scale voltage with a high-voltage level may be changed in level by the upper variable voltage distribution unit 1110 of the voltage distribution unit 1100 described above, and the gray-scale voltage with a low-voltage level may be changed in level by the lower variable voltage distribution unit 1130 of the voltage distribution unit 1100 described above.

As described above, each of the upper and lower variable voltage distribution units 1110 and 1130 comprises the plurality of variable resistor sections 1101. Accordingly, the resistance of the variable resistor sections 1101 is changes so that the voltage level of distribution voltages KVP1 to KVP9 and KVPr-8 to KVPr output by the upper and lower variable voltage distribution units 1110 and 1130 can be changed.

Further, a gap between the plurality of gray-scale voltages generated through the distribution voltages KVP1 to KVP9 and KVPr-8 to KVPr with the changed voltage level can be extended. Accordingly, a portion of the gray-scale voltage in the non-linear region is positioned at a linear region, so that the color representation can be more effectively performed.

If the voltage distributor 1100 is formed such that the hundred resistor sections between a reference voltage GVDD, i.e., a high potential voltage, and a ground voltage VSS, i.e., a low potential voltage are connected in series, eight to twenty-four of the resistor sections from the reference voltage GVDD operate as the upper variable voltage distribution unit 1110, and eight to twenty-four of the resistor sections from the ground voltage VSS operate as the lower variable voltage distribution unit 1130. Further, the other (fifty-two to eighty-four) resistor sections provided between the upper and lower variable voltage distribution units 1110 and 1130 operate as the fixed voltage distribution unit 1120. The voltage distributor 1100 generates the plurality of distribution voltages through the aforementioned plurality of resistor sections.

The multiplexer unit 1200 comprises a plurality of multiplexers 1210-1 to 1210-k. As shown in FIG. 3, it is preferred that an 8-to-1 multiplexer be used as each of the multiplexers 1210-1 to 1210-k. That is, one of eight distribution voltages is output as each of the gray-scale selection voltages VIN2 to VINm−1 depending each of external selection signals SEL1 to SELs. Further, the uppermost and lowermost distribution voltages KVP1 and KVPr do not pass through the multiplexers 1210-1 to 1210-k but are output as the uppermost and lowermost gray-scale voltages VIN1 and VINm. The gray-scale voltage output unit 1300 generates and then outputs the plurality of gray-scale voltages V1 to Vn using the plurality of gray-scale selection voltages VIN1 to VINm output by the multiplexer unit 1200.

Hereinafter, the aforementioned voltage distributor will be described with reference to the following drawings.

In the following descriptions, a voltage distributor for generating fifty distribution voltages will be described as an example.

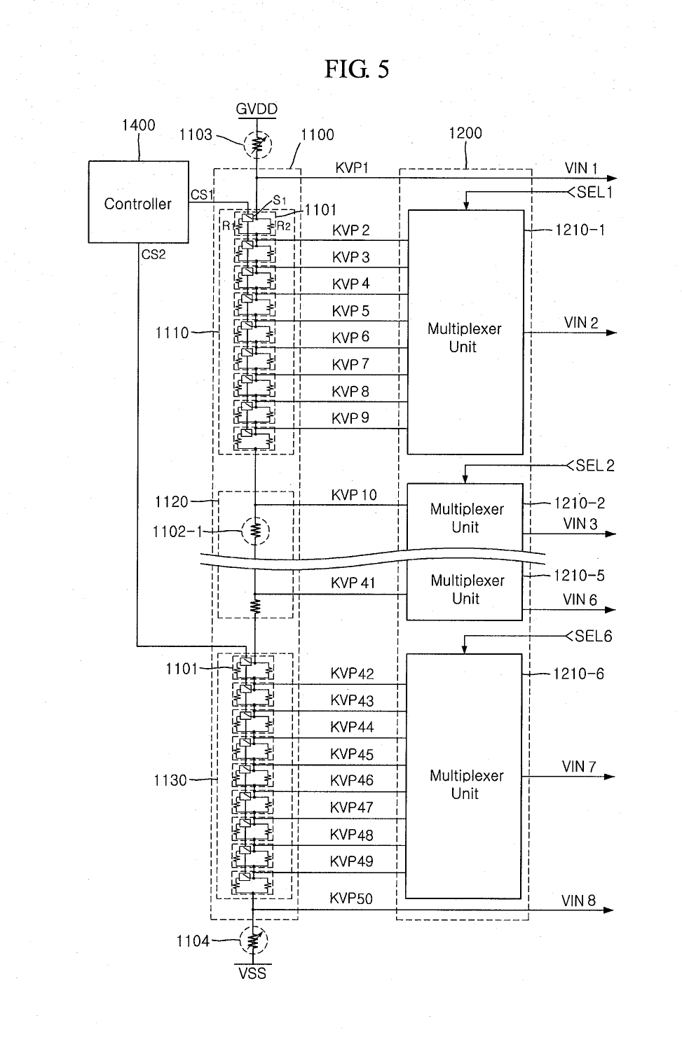

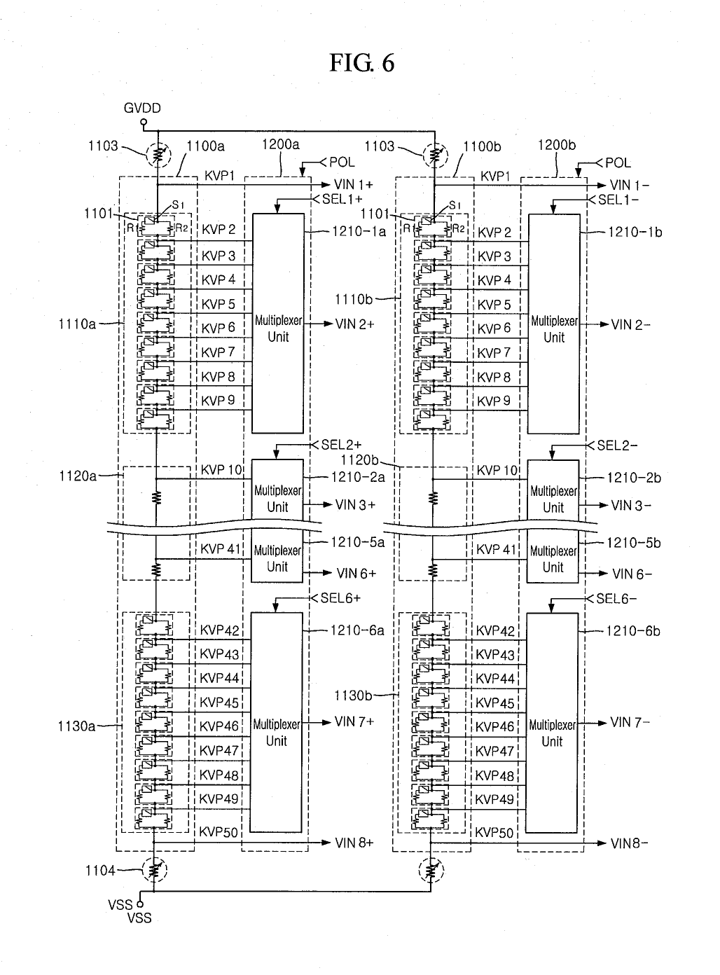

FIG. 5 is a detailed circuit diagram of a voltage distributor according to the exemplary embodiment of the present invention. FIG. 6 is a detailed circuit diagram of a voltage distributor according to a modification of the exemplary embodiment of the present invention.

Referring to FIG. 5, the voltage distributor 1100 according to this exemplary embodiment comprises the upper variable voltage distribution unit 1110, the fixed voltage distribution unit 1120 and the lower variable voltage distribution unit 1130, which are connected in series between the first and second input terminals to which the reference and ground voltages GVDD and VSS are respectively applied. At this time, an upper variable resistor 1103 is provided between the first input terminal and the upper variable voltage distribution unit 1110, and a lower variable resistor 1104 is provided between the second input terminal and the lower variable voltage distribution unit 1130. Nine of the variable resistor sections 1110 are connected in series in the upper variable voltage distribution unit 1101. Further, nine of the variable resistor sections 1101 are connected in series in the lower variable voltage distribution unit 1130. The thirty-two of the resistors are connected in series in the fixed voltage distribution unit 1120. The resistors may have resistances identical with or different from one another. Further, at least some of the resistors may have the same resistance.

Each of the variable resistor sections 1101 comprises a switch S1 and a first resistor R1, which are connected in series, and a second resistor R2 connected in parallel to the serially connected switch S1 and first resistor R1. That is, a terminal of the switch S1 and a terminal of the second resistor R2 are connected to a terminal of the variable resistor section 1101, and the other terminal of the second resistor R2 and a terminal of the first resistor R1 are connected to the other terminal of the variable resistor section 1101. Further, the other terminals of the switch S1 and the first resistor R1 are connected to each other. It is preferred that resistors with different resistances be used as the first and second resistors R1 and R2, respectively. Further, the first or second resistors R1 or R2 of the variable resistor sections 1101 may have different resistances from each other. In this exemplary embodiment, the resistance of each of the plurality of variable resistor sections 1101 is changed in accordance with the on/off operation of the switch S1 in the variable resistor section 1101. That is, when the switch S1 is turned off, the variable resistor section 1101 has the resistance of the second resistor R2. However, when the switch S1 is turned on, the variable resistor section 1101 has the parallel resistance of the first and second resistors R1 and R2.

In this exemplary embodiment, the resistance of the variable resistor section 1101 is adjusted, so that the voltage levels of the distribution voltages distributed and generated by the resistance can be controlled.

Preferably, the switch S1 of this exemplary embodiment is turned on/off in accordance with an output of an external controller 1400.

Preferably, the external controller 1400 outputs first and second control signals CS1 and CS2, and controls the operation of the switches S1 of the upper and lower variable voltage distribution unit 1110 and 1130 independently.

The outputs of the first and second control signals CS1 and CS2 may be controlled to turn on only the switches S1 of the upper variable voltage distribution unit 1110 or the lower variable voltage distribution unit 1130, or to turn on all the switches S1 of the upper and lower variable voltage distribution units 1110 and 1130. It will be apparent that all the switches S1 of the upper and lower variable voltage distribution units 1110 and 1130 may be turned off. Preferably, a flip flop is used as the aforementioned external controller 1400 in this exemplary embodiment.

Hereinafter, the operation of the gray-scale voltage generator having the aforementioned structure according to this exemplary embodiment will be described with reference to FIG. 5.

If the reference voltage GVDD is applied to the gray-scale voltage generator 1000, the voltage distributor 1100 distributes the reference voltage GVDD through the upper variable voltage distribution unit 1110, the fixed voltage distribution unit 1120 and the lower variable voltage distribution unit 1130 to generate the first to fiftieth distribution voltages KVP1 to KVP50. That is, the reference voltage GVDD is distributed by the resistors in the respective voltage distribution units 1110, 1120 and 1130.

In this exemplary embodiment, the resistances of the variable resistor sections 1101 in the upper variable voltage distribution unit 1110 and/or the lower variable voltage distribution unit 1130 are not fixed but may be varied as necessary.

The situation where both the first and second control signals CS1 and CS2 are inactivated will be discussed below.

The switches S1 of the variable resistor sections 1101 in the upper and lower variable voltage distribution units 1110 and 1130 are turned off by the inactivated first and second control signals CS1 and CS2. Accordingly, all the variable resistor sections 1101 in the upper and lower variable voltage distribution units 1110 and 1130 have the resistances of the second resistors R2. Thus, the upper and lower variable voltage distribution units 1110 and 1130 generate the distribution voltages with voltage levels corresponding to the resistance of the second resistors R2.

A case where the first control signal CS1 and the second control signal CS2, which are the outputs of the external controller 1400, are respectively activated and inactivated, will be discussed below.

As described above, the variable resistor sections 1101 in the lower variable voltage distribution unit 1130 to which the inactivated second control signal CS2 is applied have the resistances of the second resistors R2. However, the switches S1 of the variable resistor sections 1101 in the upper variable voltage distribution unit 1110 are turned on by means of the activated first control signal CS1. Accordingly, the variable resistor sections 1101 in the upper variable voltage distribution unit 1110 have the parallel resistances of the first and second resistors R1 and R2. Thus, the upper variable voltage distribution unit 1110 generates the distribution voltages with voltage levels corresponding to the parallel resistances of the first and second resistors R1 and R2, and the lower variable voltage distribution unit 1130 generates the distribution voltages with voltage levels corresponding to the resistances of the second resistors R2.

Further, where both the first and second control signals CS1 and CS2, which are the outputs of the external controller 1400, are activated will be discussed below.

When both the first and second control signals CS1 and CS2 are activated, the switches S1 of the variable resistor sections 1101 in the upper and lower variable voltage distribution units 1110 and 1130 are turned on. Accordingly, all the variable resistor sections 1101 in the upper and lower variable voltage distribution units 1110 and 1130 have the parallel resistances of the first and second resistors R1 and R2. Thus, the upper and lower variable voltage distribution units 1110 and 1130 generate the distribution voltages with voltage levels corresponding to the parallel resistances of the first and second resistors R1 and R2.

Conventionally, only fixed resistor sections are formed in a voltage distributor. Thus, distribution voltages generated through the voltage distributor had only one type. However, the voltage distributor 1100 according to this exemplary embodiment can generate four types of the distribution voltages KVP1 to KVP50 in accordance with the first and second control signals CS1 and CS2 of the controller 1400 as described above. Accordingly, the voltage distributor 1100 can generate the gray-scale voltages V1 to V64 with more various voltage levels as compared with gray-scale voltages conventionally generated by a single type of distribution voltage.

As such, the resistances of the variable resistor sections 1101 in the upper variable voltage distribution unit 1110 and/or the lower variable voltage distribution unit 1130 can be selectively adjusted in this exemplary embodiment. Accordingly, the voltage levels of the distribution voltages generated by the upper and lower variable voltage distribution units 1110 and 1130 can be finely controlled.

When the resistances of the variable resistor sections 1101 in the upper variable voltage distribution unit 1110 and/or the lower variable voltage distribution unit 1130 are changed and thus the voltage levels of the distribution voltages KVP2 to KVP9 and KVP42 to KVP 49 output therethrough are changed in the foregoing descriptions, the voltage levels of the distribution voltages KVP10 to KVP 41 output from the fixed voltage distribution unit 1120 provided between the upper and lower variable voltage distribution units 1110 and 1130 can be changed.

As described above, the first to fiftieth distribution voltages KVP1 to KVP50 are generated through the voltage distributor 1100 of this exemplary embodiment. Further, the voltage levels of the first to fiftieth distribution voltages KVP1 to KVP50 can be changed as described above. The change in the voltage levels of the first to fiftieth distribution voltages KVP1 to KVP50 means that the voltage amplitude between adjacent distribution voltages is changed.

The multiplexer unit 1200 receives the applied first to fiftieth distribution voltages KVP1 to KVP50 and then generates the first to eighth gray-scale selection voltages VIN1 to VIN8.

The multiplexer unit 1200 outputs the first distribution voltage KVP1 as the first gray-scale voltage VIN1 and the fiftieth distribution voltage KVP50 as the eighth gray-scale voltage VIN8. In addition, a first multiplexer 1210 in the multiplexer unit 1200 outputs any one of the second to ninth distribution voltages KVP2 to KVP9 as the second gray-scale selection voltage VIN2 in accordance with a first selection signal SEL1. A second multiplexer 1220 outputs any one of the tenth to seventeenth distribution voltages KVP10 to KVP17 as the third gray-scale selection voltage VIN3 in accordance with the second selection signal SEL2. A third multiplexer 1230 outputs any one of the eighteenth to twenty-fifth distribution voltages KVP18 to KVP25 as the fourth gray-scale selection voltage VIN4 in accordance with the third selection signal SEL3. A fourth multiplexer 1240 outputs any one of the twenty-sixth to thirty-third distribution voltages KVP26 to KVP33 as the fifth gray-scale selection voltage VIN5 in accordance with the fourth selection signal SEL4. A fifth multiplexer 1250 outputs any one of the thirty-fourth to forty-first distribution voltages KVP34 to KVP41 as the sixth gray-scale selection voltage VIN6 in accordance with the fifth selection signal SEL5. A sixth multiplexer 1260 outputs any one of the forty-second to forty-ninth distribution voltages KVP42 to KVP49 as the seventh gray-scale selection voltage VIN7 in accordance with the sixth selection signal SEL6. The gray-scale voltage output unit 1300 receives the applied first to eighth gray-level selection voltages VIN1 to VIN8, and then generates the first to sixty-fourth gray-scale voltages V1 to V64.

The gray-scale voltage output unit 1300 outputs the first gray-scale selection voltage VIN1 as the first gray-scale voltage V1, the second gray-scale selection voltage VIN2 as the second gray-scale voltage V2, the third gray-scale selection voltage VIN3 as the ninth gray-scale voltage V9, the fourth gray-scale selection voltage VIN4 as the twenty-first gray-scale voltage V21, the fifth gray-scale selection voltage VIN5 as the forty-fourth gray-scale voltage V44, the sixth gray-scale selection voltage VIN6 as the fifty-sixth gray-scale voltage V56, the seventh gray-scale selection voltage VIN7 as the sixty-third gray-scale voltage V63, and the eight gray-scale selection voltage VIN8 as the sixty-fourth gray-scale voltage V64. In addition, the third to eighth gray-scale voltages V3 to V8 are generated using the second and third gray-scale selection voltages VIN2 and VIN3, the tenth to twentieth gray-scale voltages V10 to V20 are generated using the third and fourth gray-scale selection voltages VIN3 and VIN4, the twenty-second to forty-third gray-scale voltages V22 to V43 are generated using the fourth and fifth gray-scale selection voltages VIN4 and VIN5, the forty-fifth to fifty-fifth gray-scale voltages V45 to V55 are generated using the fifth and sixth gray-scale selection voltages VIN5 and VIN6, and the fifty-seventh to sixty-second gray-scale voltages V57 to V62 are generated using the sixth and seventh gray-scale selection voltages VIN6 and VIN7.

The gray-scale voltages in the aforementioned non-linear range of the liquid crystals are the second to ninth gray-scale voltages V2 to V9 and fifty-seventh to sixty-third gray-scale voltages V57 and V63. As described above, these gray-scale voltages V2 to V9 and V57 to V63 are generated by the second and seventh gray-scale selection voltages VIN2 and VIN 7, respectively. Further, the voltage level of the second gray-scale selection voltage VIN2 is changed by the upper variable voltage distribution unit 1110, and the voltage level of the seventh gray-scale selection voltage VIN7 is changed by the lower variable voltage distribution unit 1130. In this exemplary embodiment, the variable voltage distribution unit 1100 is provided with the upper variable voltage distribution unit 1110 having the plurality of variable resistor sections 1101 at a region adjacent to the reference voltage GVDD and the lower variable voltage distribution unit 1130 having the plurality of variable resistor sections 1101 at a region adjacent to the ground voltage VSS, so that the voltage levels of the gray-scale voltages in the non-linear range of the liquid crystals cam be finely controlled. Accordingly, an image at the non-linear range can be smoothly represented.

Further, the gray-scale voltage generator 1000 according to this exemplary embodiment can generate and output positive and negative gray-scale voltages. To this end, the gray-scale voltage generator 1000 may comprise positive and negative voltage distributor 1100a and 1100b as shown in FIG. 6. There may be provided a positive multiplexer unit 1200a for generating positive gray-scale voltages VIN1+ to VIN8+ using the positive voltage distributor 1100a and a negative multiplexer unit 1200b for generating negative gray-scale voltages VIN1− to VIN8− using the negative voltage distributor 1100b. The positive multiplexer unit 1200a and the negative multiplexer unit 1200b may be driven according to a polarity signal POL. The gray-scale voltage output unit 1300 can generate positive gray-scale voltages V1+ to V64+ using the positive gray-scale voltages VIN1+ to VIN8+, and negative gray-scale voltages V1− to V64− using the negative gray-scale voltages VIN1− to VIN8−. The positive and negative gray-scale voltages V1+ to V64+ and V1− to V64− are generated in such a manner, so that the gray-scale voltages with different polarities can be given to a liquid crystal display.

As described above, according to the present invention, a voltage value of gray-scale voltage at a range in which the transmittance of liquid crystals is non-linearly changed with respect to the applied gray-scale voltage can be more finely selected.

Further, according to the present invention, a resistance in a range in which the transmittance of liquid crystals is non-linearly changed is selectively changed, so that the voltage level of the gray-scale voltage at the range in which the transmittance of liquid crystals is non-linearly changed can be controlled.

Although the present invention has been described in connection with the accompanying drawings and the preferred exemplary embodiments, the present invention is not limited thereto but defined by the appended claims. Accordingly, it will be understood by those skilled in the art that various modifications and changes can be made thereto without departing from the spirit and scope of the invention defined by the appended claims.

What is claimed is:

1. A gray-scale voltage producing module, comprising:
a voltage distributor for outputting a plurality of distribution voltages through an upper variable voltage distribution unit, a fixed voltage distribution unit and a lower variable voltage distribution unit which are connected in series between high and low potential voltages;
wherein each of the upper and lower variable voltage distribution units comprises a plurality of variable resistor sections connected in series, and the fixed voltage distribution unit comprises a plurality of resistor sections connected in series.

2. The module of claim 1, wherein each of the variable resistor sections comprises a switch and a first resistor connected in series to each other, and a second resistor connected in parallel to the serially connected switch and first resistor.

3. The module of claim 2, further comprising a controller for controlling the operation of the switch in the variable resistor section.

4. The module of claim 3, wherein the controller comprises two output terminals; the switches of the plurality of variable resistor sections in the upper variable voltage distribution unit are connected to one of the output terminals of the controller; and the switches of the plurality of variable resistor sections in the lower variable voltage distribution unit are connected to the other of the output terminals of the controller.

5. The module of claim 1, wherein the voltage levels of the distribution voltages output by the upper variable voltage distribution unit are higher than those of the distribution voltages output by the fixed voltage distribution unit and the lower variable voltage distribution unit, and the voltage levels of the distribution voltages output by the lower variable voltage distribution unit are lower than those of the distribution voltages output by the fixed voltage distribution unit.

6. The module of claim 1, further comprising a multiplexer unit for outputting some of the distribution voltages of the voltage distributor as gray-scale selection voltages, and a gray-scale voltage output unit for generating the gray-scale voltage using the gray-scale selection voltages.

7. A liquid crystal display (LCD), comprising:
an LCD panel for displaying an image using liquid crystals; and
a gray-scale voltage producing module for applying a gray-scale voltage to the liquid crystals,
wherein the light transmittance of the liquid crystals is non-linearly or linearly changed depending on the applied gray-scale voltage and the gray-scale voltage producing module comprises a variable voltage distribution unit for generating the gray-scale voltage at a range in which the transmittance of the liquid crystals is non-linearly changed.

8. The LCD of claim 7, wherein the gray-scale voltage producing module comprises a voltage distributor for outputting a plurality of distribution voltages through the variable voltage distribution unit and the fixed voltage distribution unit, which are connected in series; and a voltage output means for outputting the gray-scale voltage using the distribution voltages of the voltage distributor, wherein the variable voltage distribution unit includes a plurality of variable resistor sections connected in series.

9. The LCD of claim 8, wherein the variable voltage distribution unit includes upper and lower variable voltage distribution units; the voltage levels of the distribution voltages output by the upper variable voltage distribution unit are higher than those of the distribution voltages output by the fixed voltage distribution unit and the lower variable voltage distribution unit; and the voltage levels of the distribution voltages output by the lower variable voltage distribution unit are lower than those of the distribution voltages output by the fixed voltage distribution unit.

10. The LCD of claim 8, wherein each of the variable resistor sections comprises a switch and a first resistor connected in series to each other, and a second resistor connected in parallel to the serially connected switch and first resistor.

11. The LCD of claim 10, further comprising a controller for controlling the operation of the switch in the variable resistor section.

12. The LCD of claim 11, wherein the controller comprises two output terminals; the switches of the plurality of variable resistor sections in the upper variable voltage distribution unit are connected to one of the output terminals of the controller; and the switches of the plurality of variable resistor sections in the lower variable voltage distribution unit are connected to the other of the output terminals of the controller.

13. A driving method of an LCD, comprising the steps of:
generating a plurality of distribution voltages by respectively applying high and low potential voltages to both terminals of a voltage distributor, the voltage distributor including an upper variable voltage distribution unit, a fixed voltage distribution unit and a lower variable voltage distribution unit, which are connected in series, each of the upper variable voltage distribution unit, the fixed voltage distribution unit and the lower variable voltage distribution unit having a plurality of resistor sections;
generating a plurality of gray-scale voltages using the plurality of distribution voltages; and
applying the plurality of gray-scale voltages to liquid crystals in an LCD panel,
wherein the light transmittance of the liquid crystals is non-linearly or linearly changed depending on the applied gray-scale voltages, and the gray-scale voltages at a range in which the transmittance of the liquid crystals is non-linearly changed are generated using the distribution voltages generated by the upper and lower variable voltage distribution units.

14. The method of claim 13, wherein the resistance of the resistor sections in at least one of the upper and lower variable voltage distribution units is variably changed.
